(19) United States
(12) Patent Application Publication
(10) Pub. No.: US 2002/0149201 A1
(43) Pub. Date: Oct. 17, 2002

(54) Apparatus for coupling dryer to vent ducting and method of use

(76) Inventor: Michael R. Pichotta, Montgomery, TX (US)

Correspondence Address: The Matthews Firm, Suite 1800, 1900 West Loop South, Houston, TX, 77027, US

(21) Appl. No.: 10/162,013

(22) Filed: Jun. 4, 2002

Related U.S. Application Data
(63) Continuation of application No. 09/602,997, filed on Jun. 23, 2000, now abandoned.

(51) Int. Cl. F16L 5/00

(52) U.S. Cl. 285/192

(57) ABSTRACT

This apparatus and method simplifies the installation of a dryer unit to the vent ducting, and facilitates the installation and disconnection of the dryer by couplings that are self connecting and are removably and releasably attachable to one other. This invention allows the connection of a dryer exhaust pipe to vent ducting such that a unit may be positioned in close proximity to a wall whereby the exhaust of the unit may flow from the exhaust pipe, across the apparatus, to the venting system. The apparatus of this invention can also be used with additional tubing or couplings, if necessary.

This is a Continuation of U.S. application Ser. No. 09/602,997 filed on Jun. 23, 2000, which is pending.

### BACKGROUND

### BRIEF DESCRIPTION OF DRAWINGS

To understand the nature and objects of the present invention, reference should be had to the following detailed description, taken in conjunction with the accompanying drawings, wherein:

FIG. 1 is an illustration of an embodiment of the present invention hooked to the exhaust pipe of a dryer and vent ducting in a wall;

FIG. 2 is an illustration of an additional embodiment of the present invention hooked to the exhaust pipe of a dryer and vent ducting in a wall;

FIG. 3 is a larger illustration of the couplings of the embodiment in FIG. 1, with the couplings unjoined and one of the couplings anchored to a wall;

FIG. 4 is a larger illustration of the couplings of the embodiment in FIG. 2, unjoined, with one of the couplings permanently installed in the wall;

FIG. 5 is an illustration of an embodiment of the present invention viewed from the inside face of a coupling having a quadrangular base or plate;

FIG. 6 is an illustration of an embodiment of the present invention viewed from the inside face of a coupling with a circular base or plate;

FIG. 7 is a cross sectional illustration of an additional embodiment of the present invention, showing a third coupling;

FIG. 8 is an illustration of an embodiment of the present invention having a flue with an external spring;

FIG. 9 is a further illustration of a bottom view of an angular or angled coupling of the present invention like that previously shown in FIGS. 4, 7;

FIG. 9a is an illustration of the inner face of the plate or base of the invention of FIG. 9; and

FIG. 9b is an illustration of the back view and outer face of a coupling of the plate like that in the embodiments of FIGS. 4, 7, 9.

### DETAILED DESCRIPTION AND PREFERRED MODE FOR CARRYING OUT THE INVENTION

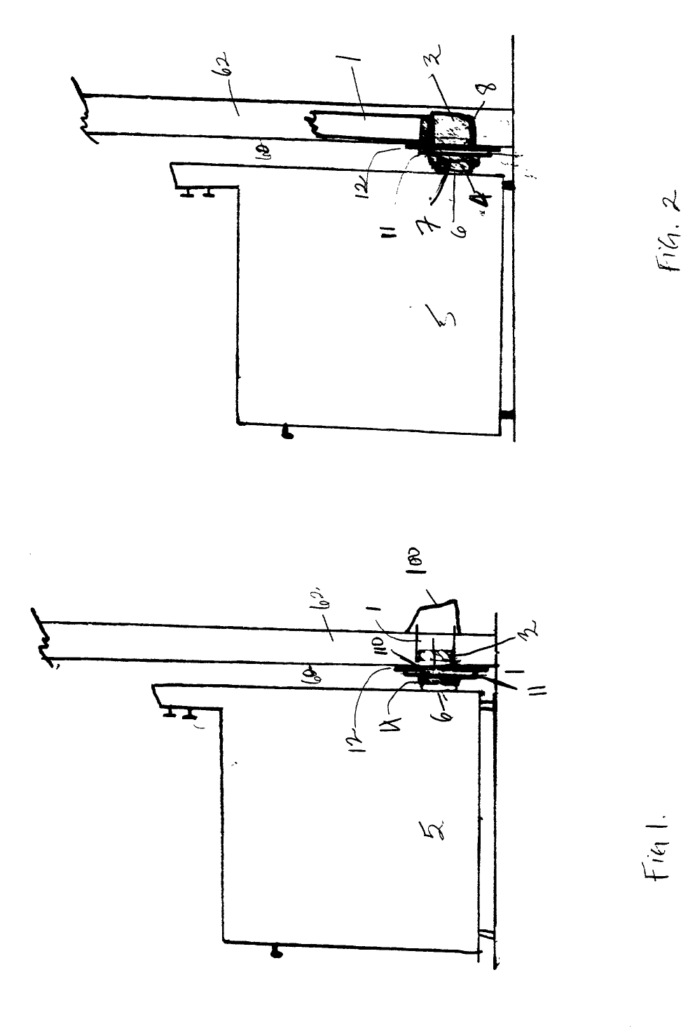

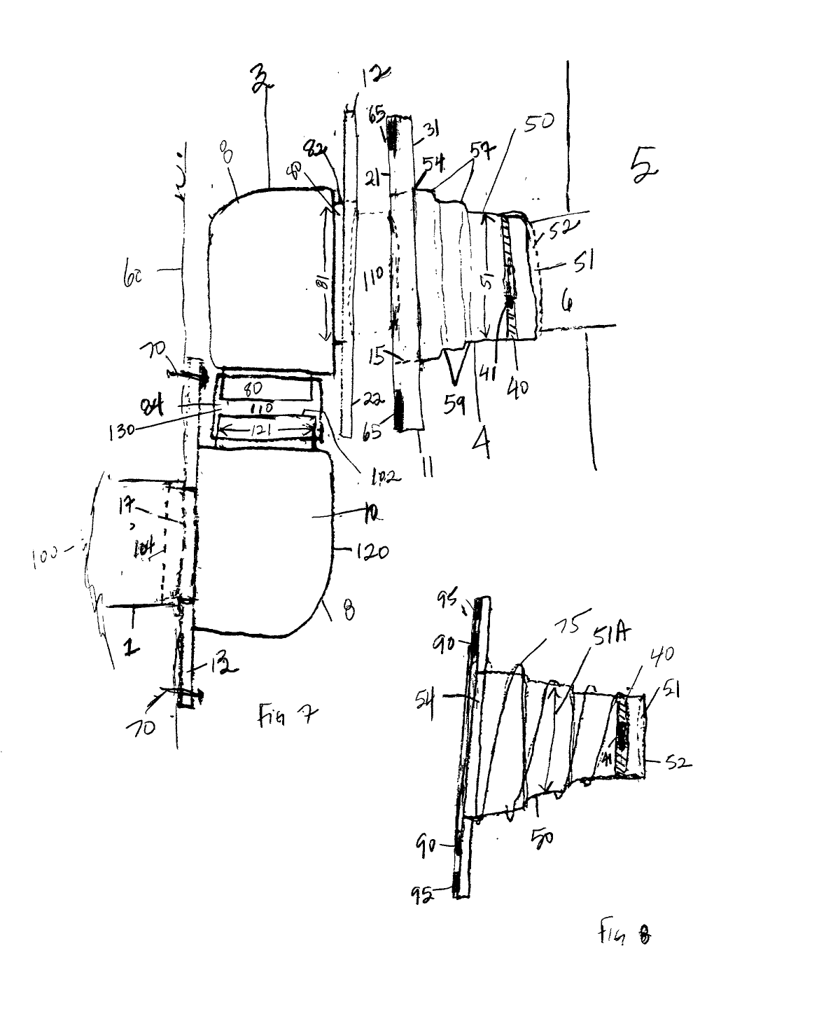

Referring now to FIG. 1, an embodiment of the present invention shows a first coupling 4 with a first plate 11 hooked to the exhaust pipe 6 of a unit such as a dryer 5 with the first plate 11 of the first coupling 4 releasably attached to the second plate 12 of a second coupling 3 which is further connected to vent ducting 1, e.g., within the wall cavity 62. While the present invention can function without a flexible conduit which is typically used to connect a dryer exhaust pipe 6 to the ducting system, a flexible or rigid tube or conduit may still be needed or used, as well as other means to compensate for the distance between the dryer exhaust pipe 6 and vent ducting 1 if they are vertically unaligned, as shown in FIG. 7, and/or horizontally distanced. Further, in this invention, dryer 5 and wall 60 or structure may be separated by a distance of a few inches and can even achieve a zero clearance between the dryer 5 and wall 60, if necessary or desired. The exhaust can also be directed upward through vent ducting in the wall cavity 62, as disclosed in FIG. 2, or ceiling (not shown) and outward through the attic and/or vent in the roof, or in any desired direction, and also out through the floor or outside wall. One of the couplings, e.g., 3 may also be a part of a permanent vent ducting system as shown in FIG. 2.

In the invention of FIGS. 1-9B, the first connecting means such as a first coupling 4 and the second connecting means such as a second coupling 3 of this invention are releasably attached to each other by a variety of way using means, such as at least one magnet, fasteners, adhesives, a wedge and aperture connection, a screw, a hook and eye, a snap, a bolt, a hinge, a staple, a nut, Velcro®, and/or a combination thereof, or with or by other materials known to one skilled in the art. This enables exhaust to pass from a dryer exhaust pipe 6, through the first coupling 4, and out and across the first aperture and second apertures 15, 16 which are aligned or in substantial alignment so as to form a throughpassage 110, and through the second coupling 3, to vent ducting 1.

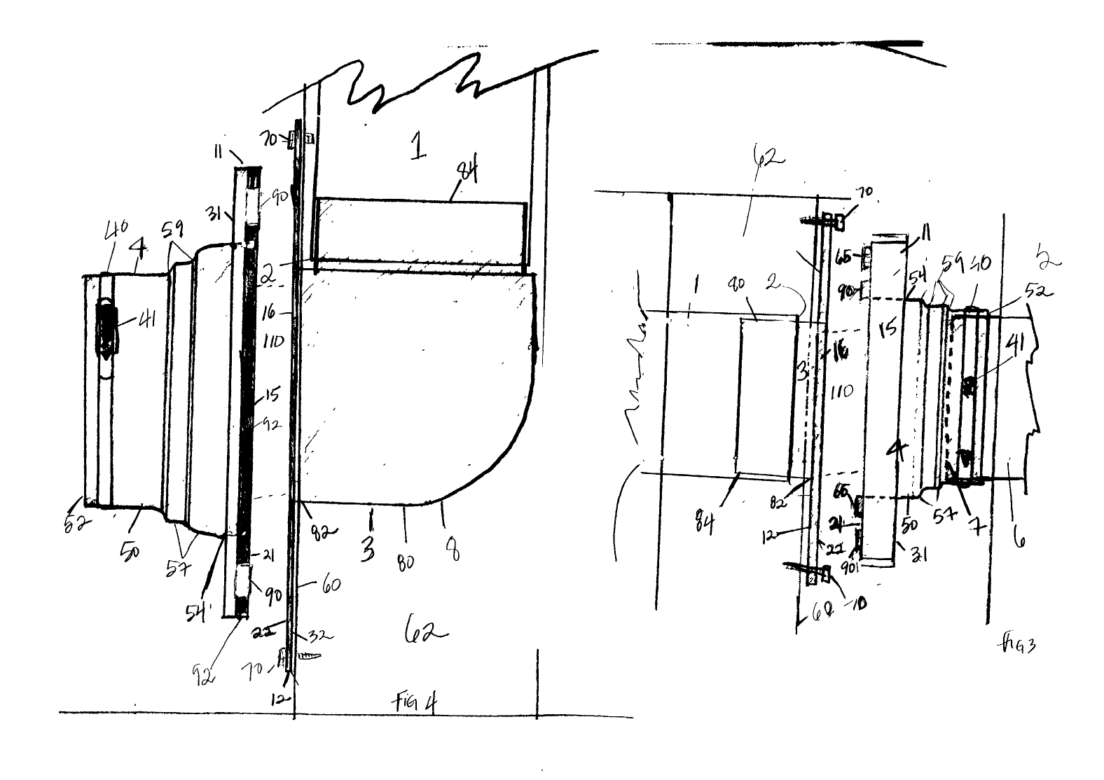

Most typically, a dryer is placed along wall 60 which has vent ducting therein which exits 100 to the outdoors as is disclosed in FIG. 1. While the joined couplings, e.g., 3, 4 in the invention in FIGS. 1, 3 provide a generally straight path for the exhaust substance to travel from the dryer 5 out end 7 (See FIG. 3) through the invention also provides an angled connection, if necessary to accommodate the location of the dryer exhaust pipe 6, with respect to the vent ducting 1, as in FIGS. 2, 4. 7.

Now referring to FIG. 3, a larger cross sectional illustration of an embodiment of FIG. 1 is shown. Herein, the first coupling 4 is comprised of a first plate or base 11 with an inner face 21, and a first aperture 15 is present in the base or plate 11. The second coupling 3, may be similarly comprised of a second plate or base 12 which has an inner face 22, and further has a second aperture 16 in the second plate or base 12. As illustrated in FIGS. 3, 4 the couplings 4, 3 are in an unattached or unjoined state. The first coupling 4 typically has a first flue 50, with an inlet end 52 which is sized for mating connection with the exhaust pipe 6 of the dryer 5, and the first flue 50 has an outlet end 54 which is connected edgewisely, at, or near, the first aperture 15 and which extends outwardly from the outer face 31 of the first plate. Further, the second coupling 3 has a second flue 80 which has an inlet end 82 which is connected edgewisely, or at or near the second aperture 16 and an outlet end 84 extends from the outer face 32 of the second plate 12 and is adaptably connected to the vent ducting 1. Similarly, the base or plate 12 of coupling 3 may also be secured to wall 60 or is attached, anchored or installed to part of the building structure such as a wall 60 by screws 70, 70, as in FIGS. 3, 4, 7, through anchors, screws, staples, adhesive, Velcro®, screws, nails, glue, tape, or a combination thereof, and any other manner or way known to one skilled in the art. Further, the outlet end 84 of the second flue 80 may also be inserted into or around at least a portion of the vent ducting 1 of the structure, permanent or otherwise.

As shown in FIGS. 1-4, the first and second coupling 3, 4 respectively, are releasably attached at their first and second inner faces 21, 22, respectively. FIGS. 3 and 4 are in a disconnected state for illustration purposes. The inlet end of the first flue 50 of the first coupling 4 is sized to matingly connect to a dryer 5 by fitting or sliding the over the exhaust pipe 6 of the unit and is then securing the matingly connected flue so it does not become detached. Alternatively, the first coupling 4 may be directly secured to the body of the dryer 5, without a flue or attached by way of a flue and also directly secured to the back of the dryer 5.

Further, an operator or installer may attach the first coupling 4 to the exhaust pipe 6 of the dryer 5 before the dryer 5 is put into position for operation, or the first coupling 4 may be installed to the dryer by the manufacturer before it is sold. After the first coupling 4 is attached to the dryer exhaust pipe 6, and the second coupling 3 is attached to the vent ducting 1, at least a portion of the inner faces of the first and second couplings 21, 22, respectively may be releasably attached. Of course, the order of installation of the first 4 and second couplings 3 (or third coupling 10 as in FIG. 7) is unimportant. The invention may be installed before or after acquiring the dryer, and may even be installed into the building or structure during original construction or during remodeling.

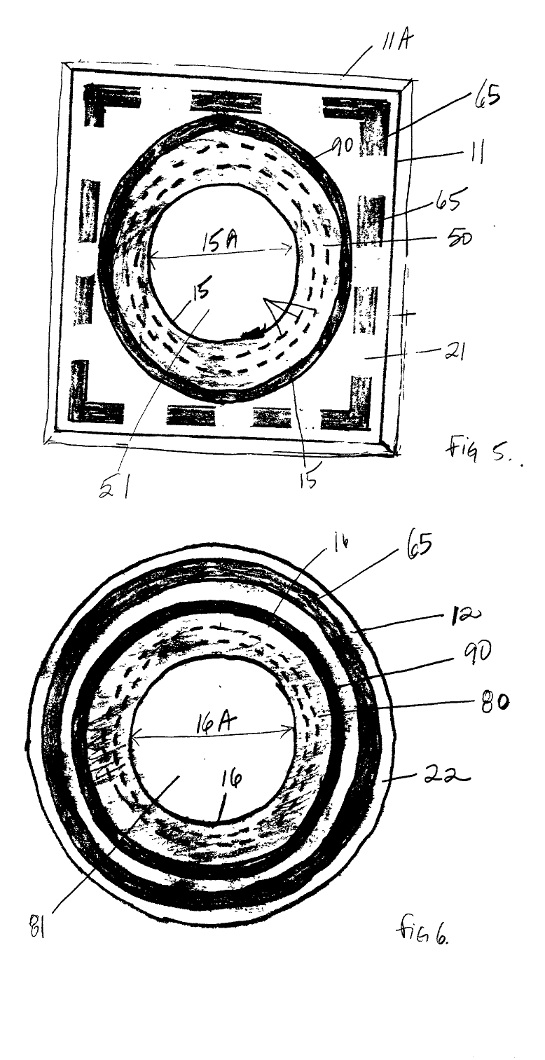

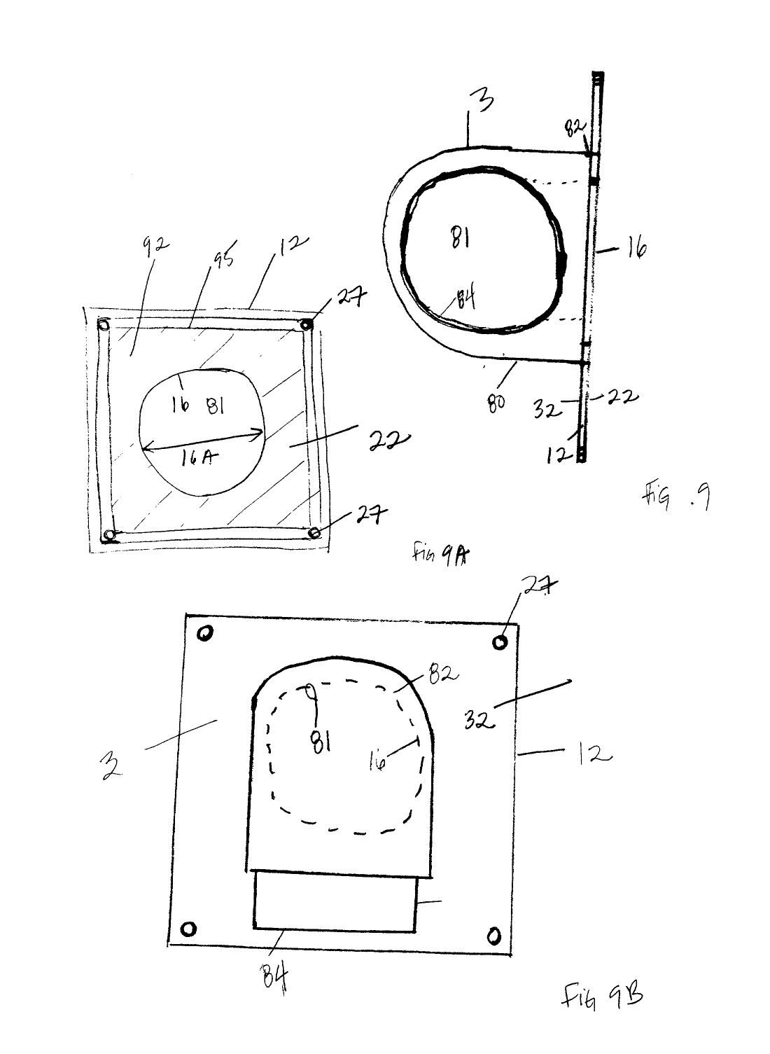

The bases or plates 11, 12, respectively, of the first and second couplings 4, 3 of FIGS. 1-9B may be of any outside shape, but are typically circular, as shown in FIG. 6, or quadrangular or rectangular, as shown in FIGS. 5, 9A, 9B, or square in shape. However, any shape will work as long as there is allowance for the inner faces 21, 22 of the plates areas outside of the apertures 15, 16 to overlap and to form a seal. Further, the bases or plates 11, 12 are also typically of the same shape, but could also be of differing shapes. The plates 11, 12 may be of different sizes, as shown in, e.g., FIG. 4. The bases or plate, e.g., 11, 12 are usually solid, i.e., except for the aperture and screw mounting holes, and may be a continuous piece or of a multi piece design. The inner face surfaces 21, 22 of the plates, 11, 12, may may also be indented in certain areas to accommodate magnets 65 or the other attachment means, as well as additional sealing means such as gaskets, e.g., 90. The inner faces 21, 22 of the bases or plates 11, 12 may also be shaped near or around the apertures for a variety of reasons such as attachment of the flues, e.g., 50, 80, and one of the plates or bases may also be indented or shaped like a funnel near the apertures (not shown), while the other correspondingly protrudes to facilitate alignment and sealing of the plates 11, 12 and/or apertures 15, 16. One of the plates or bases 11 or 12 may also have raised edges or a flange or frame that extends from the perimeter of the edge of the inside face to facilitate alignment of the plates, e.g., 11A as in FIG. 5.

The first and second plates 11, 12 of this invention may be constructed of any material common in the art, such as sheet metal, however plastic, resins, rubber, a combination thereof, and/or other materials known or used in the art, and the plates 11, 12 of this invention may be rigid or semirigid. Typically at least a portion of each base or plate 11, 12 is sheet metal and can be other types of metal which magnetically attract. However plastic, resins, rubber, or other substances may be used as well in conjunction with other means used to releasably attach the couplings 3, 4 or plates 11, 12 of this invention such as at least one magnet, Velcro®, fasteners, adhesives, magnets, a wedge and aperture connection, a screw, a hook and eye, a snap, a bolt, a hinge, a staple, a nut. In the embodiments of the invention shown in FIGS. 3-8, at least one of the bases or plates 11, 12 has magnets and/or a magnetic surface 65 or another means for releasable attachment along at least a portion, such as its perimeter, for attachment with the other base or plate. An embodiment may have only magnets 65 or other such attachment means on only one of the bases or plates 11, 12 which is attracted to metal portion of the adjacent base or plate 11, 12 of the opposing 4, 3. When the two bases or plates are preferably aligned or in substantial alignment and placed near one another, the magnetic portion 65 of the inner face 21 of one base or plate, e.g., 11 (or both) will releasably attach to the metallic portion or magnetically attractive portion(s) of the inner face 22 of the opposing base or plate, e.g., 12 and form a releasable attachment, which allows for passage of an exhaust substance through coupling 3 and coupling 4 without leaking between the attached plates 11, 12 of coupling 3 and coupling 4. Further when a predetermined number of magnets are applied to the inner surface of one of both plates and/or the magnets have a certain surface area and/or mass, the plates will magnetically attract within a certain distance, approximately 2 inches to ½ inch or less. And again, the magnets may be are applied to the inner surface of one of both plates. An embodiment of this invention, when installed and attached, will provide an exhaust substance path from a unit 5 to vent ducting 1. However, one or both ends of the couplings may be without bases or plates and the magnetic portion may be located on end of the coupling or flue or near the end of the coupling or flue (not shown). Alternatively, other attachment means previously disclosed may also removably attach the couplings or plates with or without the presence of magnets such as the Velcro® 95 as shown in FIG. 8.

The embodiment of the invention in FIGS. 1-9B has a first coupling or coupling member 4 further comprising a first flue 50 defining a first bore 51 and having a first air inlet end 52 and a first air outlet end 54, with the air inlet end 52 is sized to matingly connect to the exhaust pipe 6 and with the air outlet end being anchored to the first plate 11 edgewisely, which is to the edge, near the edge, or even into and around the first aperture 15. Similarly, the second coupling or coupling member 3 may comprise a second flue 80 which has a second bore 81 and a second air inlet end 82 and a second air outlet end 84, with the air inlet end 82 being anchored to the second plate 12 edgewisely, which is to the edge, near the edge, or even into and around the second aperture 16 and wherein the air outlet end 84 is sized to matingly connect to the vent ducting 1. The first and second flues 50, 80 are typically integral or attached to at least one end or at least a portion of the first and second bases or plates 11, 12. The flues, e.g., 50, 80 may be flush with the base or plates 11, 12, or may extend into the aperture and/or through the apertures 15, 16. However, any configuration of the making or manufacturing the flues 50, 80 to bases or plates 11, 12 will suffice, such as bridging, netting, riveting, crimping, crimping with a rolled edge, glueing, molding, and melting, and other such configurations and manufacture known to one skilled in the art or standard in the industry. The flues 50, 80 may be of any length, but are typically less than 6 to 8 inches in length, and may even be less than two inches in length. The first and second flues 50, 80, respectively are generally tubular in construction, but may be any shape, such as straight, curved, bent, angled.

The flues may also be of a constant diameter, or narrowed or widened in places. The flues may also be of a single piece, or formed from multiple pieces. The flues 50, 80 of this invention, see FIGS. 1-9B, may be rigid, semirigid, or flexible. The first flue 50 has an annular diameter at one end 52 that is sized for mating attachment with the exhaust pipe 6 exiting the unit such as a dryer 5. A common size for a diameter of an exhaust pipe 6 is three to four inches, accordingly, an embodiment of the first flue 50 typically has an annular diameter of approximately three to four inches e.g. 15A, 16A, with the first and second apertures 15, 16 having a diameter of approximately four to five inches, to also allow for misalignment between the first and second apertures 15, 16, of the first and second couplings 50, 80, respectively and/or apertures 15, 16 and/or possible misalignment of the inside faces of the first and second plates 11, 12. The first and second flues, e.g., 50, 80 may be made of any material common in the art. Examples may include sheet metal, heat resistant or heat tolerant plastic, rubber, resins, polymers and other types of materials which are known to be heat resistant or tolerant. Typically at least one of the flues, e.g., 50, 80 are flexible or have rigid portions. A flexible flue or flue portion 50, 80 allows some movement of the unit and/or the couplings, e.g., 4, 3 after a final union between the couplings 4, 3 has been made. Either or both of the flues, e.g., 50, 80 may also be designed so they can be extended in length or pulled outwardly, and can also shorten or contract. This can be accomplished in a variety of ways such as by a series of ridges 57 and folds 59 in an accordion or telescoping-like manner, which enables the flue, e.g., 50, 80 to lengthen and shorten during installation and/or use. The extendable flue may also have an external or integral spring 75 which can be wound to pull the flue inwardly or push the flue outwardly as in FIG. 8. The allowance of some movement may be advantageous for washer and dryer alignment because many washer and dryer units vibrate during operation and because the flow of dryer exhaust may cause the flues, e.g., 50, 80 to move. One common manner or means of securing the mainly connected flue or flues, e.g., 50, 80 is the utilization of a metal or plastic band 40. The band 40 may be located near the end 52 of the first flue 50 of the first 50 coupling 4 and tightened by turning or sliding a screw 41 until band 40 grips the exhaust pipe 6 of the unit such that a secure, non-leaking connection is made. However, the invention also contemplates the use of a tie, plastic ties, plastic zip ties, clamps, tension clamps, rope, string, adhesive tape, duct tape, rubber bands, cloth bands with Velcro® and/or snap closures, hoses, and other securing means and devices commonly used and known in the art. The securing means such as band 40 must be sufficiently tight to prevent detachment or leaking of exhaust. Alternatively, the first coupling 4 may be magnetically or otherwise removably or securably attached directly to the back of the appliance such as a dryer 5 through means such as magnets, Velcro®, adhesive, screws, and securing means and devices commonly used and known in the art and a combination thereof.

If either flues, e.g., 50, 80, 120 extend through the apertures 15, 16, 17, they must be sized to matingly connect. If the flues matingly connect, they will further facilitate alignment of the apertures and will minimize exhaust leakage.

The inlet end 52 of the first flue 50 may be secured to exhaust pipe 6 by any method that affects or secures connection to the exhaust pipe 6 and the outlet end 84 of the second flue may also be secured to the vent ducting 1 if the outlet end does not already securably connect to the vent ducting 1. One embodiment in FIGS. 3, 4, 7, 8 utilizes a metal band 40 and screw 41.

After installation of the couplings 3, 4, the unit may be placed into service by simply aligning the edges of the first and second plates 11, 12 of coupling 3 with coupling 4 and/or aligning the first and second apertures 15, 16 and moving the unit toward wall 60 until the couplings become removably attached and a seal is formed between coupling 3 and coupling 4. The seal will allow the exhaust substance to pass through coupling 4, the aligned or substantially aligned apertures 15, 16 forming a throughpassage 110 through coupling 3 and out vent ducting 1. After installation, an operator or installer may simply detach the couplings 3, 4 (and/or 10) and move the unit away from wall 60 whenever access is needed between the unit and the wall 60 and simply move the dryer back to releasably attach the couplings when access is not longer needed.

Referring now to FIG. 5, an illustration of an embodiment of the present invention viewed from an inside face 21 and/or 22 of a quadrangular base or plate, e.g., 11 or 12 which may be utilized in different embodiments of the present invention. In this embodiment, it may be observed that base or plate, e.g., 11, 12 is quadrangular with a first apenture 15 or second aperture 16 (not shown) and a diameter 15A of approximately 3-5 inches with a first flue 50 attached edgewisely of the aperture 15, with the inner face surface, e.g., 21, 22 having magnets 65 or a magnetic portion 65 located about the base or plate 11. Additionally, gasket 90, as previously described, may be again used to aid in sealing the connection of base or plate, e.g., 11, 12 such that an exhaust substance may not substantially escape from between the bases or plates, e.g., 11, 12.

Referring now to FIG. 6, an illustration of an embodiment of the present invention viewed from a face of a circular base or plate, construction of the base or plate, e.g., 11, 12 may be observed with a second aperture 16 with a diameter 16A of approximately 3-5 inches and a second flue 80 attached edgewisely of the second aperture 16. Base or plate 11 may be constructed by any manner common in the art. Additionally, a magnetic portion 65 may be located on the inner face of either or both plates 11, 12. As shown in FIGS. 5-6, magnetic portion 65 may be continuous or may be in several pieces or portions and/or any shape (e.g., squares, rectangles, ovals, triangles, or other quadrangular shapes and a combination thereof) located at various locations of the plate and/or the perimeter of the plate. Further, the attachment means may not be a magnet or magnets at all and may be constructed of another substance capable of releaseable attachment or engagement with another portion such as at least one magnet, fasteners, adhesives, magnets, a wedge and aperture connection, a screw, a hook and eye, a snap, a bolt, a hinge, a staple, a nut, Velcro®, or an interference fit, and/or a combination thereof, or with or by other materials known to one skilled in the art that are capable of forming a releasable connection between two separate parts, e.g., as in FIGS. 7-8. Additionally, a liner 92 (See, e.g., FIG. 4, 9A), or portion of a liner such as a gasket 90 (e.g., FIGS. 3-4, 5, 6), may be placed on the inside face, e.g., 21, 22 of base or plate 11 and/or 12 to aid in sealing base or plate with another portion to prevent exhaust from escaping out the throughpassage 110 (See, e.g., FIGS. 3, 4, 7) formed when the apertures of the bases or plates 11, 12 of FIGS. 1-9B are connected. Any material maybe used as a gasket or liner, for example, felt, plastic and adhesive, rubber, and others that effectuate a seal with base or plate 11, 12 and another portion and the magnets and/or velcro may also be used as gaskets and/or liner.

Referring now to, e.g., FIGS. 3, 4, and 7, it maybe observed that a variety of methods may be utilized to attach portions of the present invention to the corresponding points of attachment, such as a wall and dryer exhaust pipe, while still obtaining the benefits of the present invention. Again, the flue, e.g., 50 of the base or plate 11 which is attached over the end 7 of an exhaust pipe 6 around end 52 may also have a band 40 secured around the matingly attached flue to prevent detachment. See, e.g., FIG. 3. Further, a screw 70 maybe threadingly engaged with wall 60 to secure the base or plate 12 to the wall 60. See, e.g., FIGS. 3, 4, and 7. Any number of screws 70 may be used to secure base or plate, e.g., 12, and typically a plurality of holes 27, 27, which may also be sunken, recessed, and/or beveled are defined on the base or plate 12 to recess the screw 70 or other attachment means so that the head of the screw is flush with the plate. However, the invention contemplates use of any anchors common in the art such as bolts or adhesives. Furthermore, wall 60 may be a wall of a unit and the base or plate, e.g., 11 may be attached directly to the dryer unit either before or after the unit is acquired.

Referring now to FIG. 7, an illustration of embodiments of the present invention with a rigid or semi-rigid coupling, e.g., 3 and/or 10 in an angular attachment arrangement with an elbow 8 within the couplings 3, 10, it may be observed that different connections are contemplated within the spirit of the present invention. See FIGS. 4, 7, 9, 9B. The first, second, and third bores 51, 81, 121, respectively, of the first flue 50, second flue 80, and third flue 120 may vary in diameter, between the flues and within the length of each flue, respectively. The first flues 50 of the embodiments in FIGS. 3, 4, 7, 8 are flexible and horizontally extended or telescoped outwardly from the outside face, e.g., 31 of the first plate 11. And again, the second flue of the second plate and/or third flue of the third plate can also be flexible and have ridges (not shown). The flexible flues further may have ridges 57 and folds 59. Again, the inlet end 52 of the first flue 50 is sized for mating connection with the vent pipe 5 and has a band 40 and screw 41 tightened around the connection to prevent the first flue 50 from becoming detached from the vent pipe 5. Also as shown in FIG. 8, the flue 50 (or second or third flues, e.g., 80, 120) may also have a spring 75 which is external or internal, or within the flue, which may be wound to either push the flue inwardly or outwardly from the plate, e.g., 11, and may assist in attachment of the couplings. As will be seen by those skilled in the art, the couplings may be generally the same distance from a floor or lower surface to be appropriately attached as in FIGS. 1-4, or displaced horizontally, and/or vertically as in FIG. 7. The embodiment in FIG. 7 further has a third coupling 10 with a third plate 13, a third aperture 17 and a third flue 120 having a third bore 121 and an air inlet end 102 and an air outlet end 104 which may be directly connected with or joined to the second coupling 3 (not shown) or joined by a connecting insert 130 to allow connection where the exhaust pipe 6 and vent ducting 1 are offset, as generally shown in FIG. 7. Again, the base or plate 13 of the third coupling 10 may be secured to a wall by a bolt, screw, nail or other suitable means 70 for attachment. For example, the second or middle coupling 3 may be at a 90-degree angle from the first coupling which then further is connected to another coupling 10 having a 90-degree angle. Of course, the couplings may again be straight or unangled, and of a variety of other angles may be used as necessary to accommodate offsetting, and portions of the couplings may also be further rotatable. In this embodiment, screw 70 is used to secure base or plate 13 to a wall 60 and the outlet of the flue 104 is connected to the vent ducting 1.

Referring now to angular attachment coupling and flues of FIGS. 7, 9, 9a, 9b, the flue of the coupling is angled. The angled flue would typically be rigid or semirigid, and the coupling may further be rotatable near or at the inlet and/or outlet end of the flue, e.g., 82, 84, respectively. Also, as in FIG. 9a, the inner surface of the plate may have a lining which extends to the aperture.

Referring again to FIG. 7, an illustration of an embodiment using a first coupling with a flexible flue and a second angular coupling attached by its inner face 22 to the inner face 21 of the plate 11 of the first coupling, it may be observed that a different orientation of a coupling 3 (or 4, and/or 10) is within the spirit of the present invention.

A method of coupling a dryer exhaust pipe 6 to vent ducting 1 is also contemplated by the present invention generally comprising the steps:

attaching a first coupling member comprising a first plate with an inner face and defining a first aperture to a dryer exhaust pipe;

attaching a second coupling member comprising a second plate with and inner face and defining a second aperture to vent ducting;

moving the dryer backwards toward the second coupling member;

aligning or substantially aligning the first and second coupling members so the first and second apertures form a throughpassage; and

releasably attaching the first and second coupling members.

This method may also further comprise:

causing a magnetic engagement between at least a portion of the first and second inner faces, and allowing the flow of air therethrough.

In this method, the first coupling member may further comprise a first flue defining a first bore and having open air inlet and outlet ends, the air inlet end sized for mating with the exhaust pipe and the air outlet end sized for mating with the aperture and fixedly attached to the first plate.

Also in this method, the second coupling member may further comprise a second flue defining a second bore and having open air inlet and outlet ends, with the air inlet end sized for mating with the second aperture and the air outlet end sized for mating with the vent ducting, the second inlet end fixedly attached to the second plate.

The method may also further comprise:

turning the dryer on and allowing exhaust to flow from the dryer, through the first coupling member, the throughpassage, and through the second coupling member, and to the vent ducting.

The method may also further comprise a third coupling member, wherein the third coupling member comprises a third plate with an aperture and a third flue defining a third bore and having a third air inlet end and a third air outlet end, with the air outlet of the second coupling member sized to matingly connect to the third coupling member, and wherein the second outlet end is matingly connected to the third air inlet end, and wherein the third outlet end is anchored to the third plate around the third aperture and/or is sized to matingly connect to the vent ducting.

The method may also comprise a connecting insert between the second and third connecting means.

This method may also further comprise:

turning the dryer on and allowing exhaust to flow from the dryer exhaust pipe, through the first, second, and third coupling members, and out to the vent ducting.

Also in this method, the means for releasable attachment may be selected from the group consisting of a stud and aperture connection; velcro; fasteners; adhesives; a hinge; a magnet; a wedge and aperture connection; a screw; a bolt; a hinge; a staple; a nut; and a combination thereof.

It is noted that the embodiment of apparatus described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

I claim:

1. An apparatus for coupling a dryer exhaust pipe to vent ducting, the apparatus comprising:
a first coupling member comprising a first plate having a first aperture and an inner face, said first member adapted to connect to said dryer exhaust pipe; and
a second coupling member comprising a second plate having a second aperture and an inner face, said second coupling member adapted to connect to said vent ducting, wherein at least a portion of the inner faces of said first and second plates are further capable of releasable attachment.

2. The apparatus of claim 1, wherein said first and second apertures are circular or substantially circular.

3. The apparatus of claim 2, wherein said first and second apertures are approximately at least three to five inches in diameter.

4. The apparatus of claim 3, wherein the first coupling member further comprises a first flue defining a first bore and having a first air inlet end and a first air outlet end, and wherein said air inlet end is sized to matingly connect to said exhaust pipe and wherein said air outlet end is anchored to said first plate edgewisely of first said aperture.

5. The apparatus of claim 4, wherein the second coupling member further comprises a second flue defining a second bore and having a second air inlet end and a second air outlet end, and wherein said air inlet end is anchored to said plate edgewisely of second said aperture and wherein said air outlet end is sized to matingly connect to said vent ducting.

6. The apparatus of claim 5, wherein at least a portion of said first and/or second inner faces are releasably attached by at least one magnet and/or by velcro.

7. The apparatus of claim 6, wherein at least a portion of said inner faces are releasably attached, and wherein said first and second apertures are aligned or substantially aligned to allow the flow of air therethrough.

8. The apparatus of claim 7, further having a band secured around said matingly connected first and/or second flue to inhibit detachment.

9. The apparatus of claim 7, having at least one gasket or liner disposed between said inner faces of said first and/or second plates to prevent exhaust from escaping from between said attached plates.

10. The apparatus of claim 9, wherein said gasket is located in the same or substantially same plane as said at least one magnet and/or velcro.

11. The apparatus of claim 9, wherein said gasket and/or magnet and/or velcro are disposed within indentations in the inner face of the first and/or second said plates.

12. The apparatus of claim 6, wherein at least one of said first or second flues is flexible and is made from at least one of the materials selected from the following group consisting of metal; plastic; rubber; vinyl; epoxy; composite; polymers; and a combination thereof.

13. The apparatus of claim 12, having a spring integral with or on the outside of said flexible flue.

14. The apparatus of claim 7, wherein at least one of said flues is rigid or semirigid and is made from at least one of the materials selected from the group consisting of metal; plastic; rubber; vinyl; epoxy; composite; polymers; and a combination thereof.

15. The apparatus of claim 7, wherein said first flue is capable of fixed or releasable connection to said exhaust pipe, and wherein said second flue is capable of fixed or releasable connection to said vent ducting.

16. The apparatus of claim 7, wherein said first flue is flexible and said second flue is rigid or semi-rigid.

17. An apparatus for coupling a dryer exhaust pipe to a vent duct, the apparatus comprising:
a first plate having an inner face and defining a first aperture;
a first flue defining a first bore and having open air inlet and air outlet ends, wherein said air inlet end is sized to matingly connect to said dryer exhaust pipe and wherein said air outlet end fixedly attaches to said first plate edgewisley of first said aperture;
a second plate having an inner face and defining a second aperture;
a second flue defining a second bore and having open air inlet and air outlet ends, wherein said air inlet end fixedly attaches edgewisley to second said aperture of second said plate and wherein said air outlet end is sized to matingly connect to said vent ducting; and
at least one magnet disposed on the inner face of the first and/or second said plates, wherein said magnet allows releasable attachment of at least a portion of said inner faces of said plates.

18. The apparatus of claim 17, wherein at least a portion of the inner faces of said first and second plates are releasably attached and said first and second apertures are aligned or substantially aligned to allow the flow of air therethrough.

19. The apparatus of claim 18, wherein either said first and second plate has a raised edge or flange for aligned attachment of said plates.

20. The apparatus of claim 18, wherein the means for releasable attachment of said inner faces is selected from the group consisting of a stud and aperture connection; velcro; fasteners; adhesives; a hinge; a magnet; a wedge and aperture connection; a screw; a bolt; a hinge; a staple; a nut; and a combination thereof.

21. The apparatus of claim 18, having at least one gasket or lining disposed between said plates and in the same plane as said magnet to inhibit exhaust from escaping from between said plates.

22. The apparatus of claim 18, wherein at least a portion of one of said flues is flexible.

23. The apparatus of claim 22, having a flexible flue and a spring integral with said flue or on the outside of said flexible flue.

24. The apparatus of claim 18, wherein at least one of said first or second flues has a band secured around said mating connection to prevent detachment.

25. The apparatus of claim 18, wherein at least a portion of one of said flues is rigid or semirigid.

26. An apparatus for coupling a dryer exhaust pipe to vent ducting, said apparatus comprising:
a first connecting means having a first plate an inner face and a first aperture, wherein said connecting means is further adapted to connect to said exhaust pipe;
a second connecting means having a second plate with an inner face and a second aperture, where said connecting means is further adapted to connect to said vent ducting; and
wherein said first and second inner faces are adapted to releasably attach to one another and wherein said first and second apertures form a throughpassage when said apertures are aligned or substantially aligned to allow the flow of air therethrough.

27. The apparatus of claim 26, said first connecting means further comprising a first flue defining a first bore and having a first air inlet end and a first air outlet end, wherein said air inlet end is sized to matingly connect to said dryer exhaust pipe and wherein said air outlet end is anchored around said first said aperture.

28. The apparatus of claim 27, said second connecting means further comprising a second flue defining a second bore and having a second air inlet end and a second air outlet end, wherein said air inlet end is anchored to said plate around said second said aperture, and wherein said outlet end is size to matingly connect to said vent ducting.

29. The apparatus of claim 28, wherein at least a portion of the inner face of said first and second connecting means are releasably attached and during dryer use exhaust flows from said exhaust pipe through said first connecting means, across said throughpassage, and through said second connecting means and into said vent ducting.

30. The apparatus of claim 28, further having means that releasably attach said first and second connecting means, wherein said means for releasable attachment is selected from the group consisting of a stud and aperture connection; at least one magnet; velcro; fasteners; adhesives; magnets; a wedge and aperture connection; a screw; a hook and eye; a snap; a bolt; a hinge; a staple; a nut; and a combination thereof.

31. The apparatus of claim 28, further comprising at least one sealing means disposed between said inner faces of said first and/or second connecting means to inhibit exhaust from escaping from between said attached connecting means.

32. The apparatus of claim 31, wherein said sealing means comprises a gasket located within in the same or substantially same plane as said means for releasable attachment.

33. The apparatus of claim 28, wherein at least one of said flues is flexible.

34. The apparatus of claim 33, having a spring integral with and/or on the outside of said flexible flue.

35. The apparatus of claim 28, further having means for securing said matingly connected first or second said flue to said exhaust pipe and/or said vent ducting.

36. The apparatus of claim 28, wherein at least one of said flues is rigid or semirigid.

37. The apparatus of claim 27, further comprising a second connecting means and a third connecting means, said second connecting means further comprising a second flue defining a second bore and having a second air inlet end and a second air outlet end, wherein said air inlet end is anchored to said plate around said second said aperture, and wherein said second outlet end is sized to matingly connect to said third connecting means, and wherein said third connecting means comprises a third plate with an aperture and a third flue defining a third bore and having a third air inlet end and a third air outlet end, wherein said third air inlet end is matingly connected to said second outlet end, and wherein said outlet end is anchored to said third plate around said third aperture and/or is sized to matingly connect to said vent ducting.

38. The apparatus of claim 37, further having a connecting insert between said second and third second connecting means.

39. A method of coupling a dryer exhaust pipe to vent ducting comprising the steps:
attaching a first coupling member comprising a first plate with an inner face and defining a first aperture to a dryer exhaust pipe;
attaching a second coupling member comprising a second plate with and inner face and defining a second aperture to vent ducting;
moving the dryer backwards toward said second coupling member;
aligning or substantially aligning said first and second coupling members so the first and second said apertures form a throughpassage; and
releasably or removably attaching said first and second coupling members.

40. The method of claim 39, further comprising:
causing a magnetic engagement between at least a portion of said first and second inner faces, and allowing the flow of air therethrough.

41. The method of claim 40, wherein said first coupling member further comprises a first flue defining a first bore and having open air inlet and outlet ends, said air inlet end sized for mating with said exhaust pipe and said air outlet end sized for mating with said aperture and fixedly attached to said first plate.

42. The method of claim 41, wherein said second coupling member further comprises a second flue defining a second bore and having open air inlet and outlet ends, said air inlet end sized for mating with said second aperture and said air outlet end sized for mating with said vent ducting, said inlet end fixedly attached to said second plate.

43. The method of claim 42, further comprising:
turning the dryer on and allowing exhaust to flow from said dryer, through said first coupling member, said throughpassage, and through said second coupling member, and to said vent ducting.

44. The method of claim 41, further comprising a second coupling member and a third coupling member, said second coupling member further comprising a second flue defining a second bore and having a second air inlet end and a second air outlet end, wherein said air inlet end is anchored to said plate around said second said aperture, and wherein said second outlet end is sized to matingly connect to said third coupling member, and wherein said third coupling member comprises a third plate with a third aperture and a third flue defining a third bore and having a third air inlet end and a third air outlet end, wherein said second outlet end is matingly connected to said third air inlet end, and wherein said third outlet end is anchored to said third plate around said third aperture and/or is sized to matingly connect to said vent ducting.

45. The method of claim 44, further having a connecting insert between said second and third connecting means.

46. The method of claim 45, further comprising:
turning the dryer on and allowing exhaust to flow from said dryer exhaust pipe, through said first, second, and third coupling members, and out to said vent ducting.

47. The method of claim 39, wherein the means for removable and releasable attachment is selected from the group consisting of a stud and aperture connection; velcro; fasteners; adhesives; a hinge; a magnet; a wedge and aperture connection; a screw; a bolt; a hinge; a staple; a nut; and a combination thereof.
